(19) United States
(12) Patent Application Publication
(10) Pub. No.: US 2026/0117906 A1
(43) Pub. Date: Apr. 30, 2026

(54) FLUIDIC CONNECTOR FOR A FLUID CIRCUIT

(71) Applicant: HUTCHINSON, Paris (FR)

(72) Inventors: Antoine THILLET, MONTARGIS (FR); Steeven ESCURE, AUVILLIERS EN GÂTINAIS (FR)

(21) Appl. No.: 19/372,519

(22) Filed: Oct. 29, 2025

(30) Foreign Application Priority Data
Oct. 30, 2024 (FR) 2411881

(51) Int. Cl. F16L 37/12

(52) U.S. Cl. CPC F16L 37/1225

(57) ABSTRACT

A fluidic connector for a fluid circuit, in particular automotive, is disclosed. The connector comprises a male end piece of the SAE type and a female end piece. The fluidic connector comprises a body and a single pin mounted astride the body and capable of axially retaining the male end piece in the female end piece. The pin is formed in a single piece and comprises a first pair of lateral tabs comprising, at their free ends, ramps and gripping projections suitable for being handled by an operator in order to move the pin, and a second pair of lateral tabs comprising, at their free ends, first teeth oriented parallel to the axis and able to cooperate with complementary second teeth of the body.

### CROSS-REFERENCE TO RELATED APPLICATIONS

This present application claims priority to French Patent Application No. 2411881, filed October 30, 2024, the disclosure of which is hereby incorporated by reference in its entirety.

### TECHNICAL FIELD OF THE INVENTION

The invention relates to a fluidic connector for a fluid circuit, in particular automotive.

### TECHNICAL BACKGROUND

A fluid circuit, in particular automotive, may comprise a number of fluidic connectors allowing sections of the circuit to be connected together or equipment to be connected to the rest of the circuit.

These connectors are generally "quick connect" (QC) connectors, which have the advantage of allowing a rapid fluidic connection between two elements to be connected. This connection is usually made manually.

Typically, a fluidic connector comprises a male end piece and a female end piece, the male end piece being engaged in the female end piece.

Among the known types of QC and connectors are the VDA and SAE technologies. The present invention relates to the SAE technology, which is characterized by an end piece which comprises an external annular rib.

To ensure the retention of the male end piece in the female end piece, it is known to fit pins or latches to the female end piece, a first of these pins being configured to cooperate with the rib of the male end piece to ensure its retention in the female end piece, and a second of these pins being generally configured to lock the first pin in its position of retention of the male end piece or to confirm that the first pin is correctly locked.

The present invention proposes an improvement to this technology which, in particular, allows to simplify the manufacture of the fluidic connector while retaining at least some of the functions mentioned above (cooperation with the rib of the end piece, locking, indicator of correct positioning, etc.).

### SUMMARY OF THE INVENTION

The present invention relates to a fluidic connector for a fluid circuit, in particular automotive, this connector comprising a male end piece of the SAE type comprising an external annular rib, and a female end piece suitable for receiving the male end piece, the female end piece comprising:

a body comprising an internal fluid passage extending from an inlet to an outlet, said passage being adapted to receive the male end piece by engagement from the inlet along an axis, and

a single pin mounted astride the body and capable of axially retaining the male end piece in the passage of the body,

the pin being formed in a single piece and being movable in a plane perpendicular to the axis from a raised position for releasing the male end piece to a lowered position for retaining the male end piece,

the pin comprising a first pair of lateral tabs which are located on either side of said axis and which extend parallel to the plane from a median part of the pin, the tabs of the first pair comprising, at their free ends opposite the median part, ramps on which the rib of the male end piece may bear when the pin is in the raised position and when the male end piece engages in the female end piece, in order to move these tabs elastically away from one another, the tabs of the first pair being able to cooperate by bearing axially against the rib of the male end piece when the pin is in the lowered position, in order to retain the male end piece axially in the female end piece, the tabs of the first pair also comprising, at their free ends, gripping projections that may be manipulated by an operator in order to move the pin from its lowered position to its raised position, the pin further comprising a second pair of lateral tabs which are located on either side of said axis and which extend parallel to the plane from the median part of the pin and at an axial distance from the tabs of the first pair, the tabs of the second pair being located between the tabs of the first pair and said inlet and comprising, at their free ends opposite the median part, first teeth which are oriented parallel to the axis on the side opposite the first pair of tabs and which are able to cooperate by bearing with complementary second teeth of the body in order to define said raised position and prevent the pin from becoming accidentally detached from the body.

A first special particularity of the fluidic connector according to the invention is that it comprises a single pin or a single latch, as opposed to at least two in general in the prior art.

Another particularity of the invention is that the pin comprises two pairs of tabs with different functions.

The tabs of the first pair are configured to resiliently snap-engage with the rib of the male end piece to retain the male end piece in the female end piece. The tabs of the first pair of tabs also comprise gripping projections that allow an operator to manually move the pin from its lowered position to its raised position. The pin may then move from its raised position to its lowered position. The movement is preferably automatic. The dismantling, i.e. the movement of the pin from its lowered position to its raised position, may be done manually or using a tool, for example.

The function of the teeth of the second pair of tabs is to cooperate with the female end piece, particularly when the pin is in the raised position, to render the pin captive.

The connector according to the invention may comprise one or more of the following characteristics, taken singly with each other or in combination with each other:

the tabs of the first pair have a capacity for elastic deformation in bending about axes parallel to the aforementioned axis, which is greater than that of the tabs of the second pair;

the tabs of the first pair have, at the level of their connection to the median part, a radial thickness which represents less than half or even less than one third of a radial thickness of the tabs of the second pair at the level of their connection to the median part, the radial thicknesses being measured with respect to the aforementioned axis;

each of the first teeth comprises a plane upper face bearing on a plane lower face of each of the second teeth, the upper faces of the teeth of the first pair of tabs being located in the same plane parallel to the axis;

the first teeth project from an end face of the pin which extends over the tabs of the second pair as far as the median part;

a boss projects from the end face, this boss defining two lateral guide edges which are located on either side of said axis and which are able to cooperate by sliding with complementary tracks of the body when the pin is moved between its raised and lowered positions;

the tabs of the first pair comprise two first hooks which are oriented radially towards the axis and which are capable of cooperate by bearing with complementary second hooks or notches of the body in order to prevent the pin from moving from its raised position to its lowered position without the tabs of the first pair being moved away by the rib of the male end piece;

the first hooks are located axially just behind the ramps with respect to the direction of engagement of the male end piece in the female end piece;

the first hooks are located at the level of the gripping projections;

the gripping projections define a maximum width of the pin;

the tabs of the second pair respectively comprise two first concave curved edges having a diameter greater than or equal to an external diameter of the rib of the male end piece, and two second convex curved edges having a diameter less than this external diameter, the first edges being centered on the axis when the pin is in the raised position, and the second edges being centered on the axis when the pin is in the lowered position;

the second edges are thickened axially relative to the first edges to form axial projections on the same side of the tabs of the first pair;

the pin comprises at least one indexing and/or guiding element able to cooperate by complementary shapes with a complementary element of the body;

the body comprises a tubular section and a ring, the ring being coaxial with the tubular section and connected to the tubular section by two material bridges parallel to the axis and diametrically opposed with respect to this axis, the pin being mounted astride either side of the two material bridges;

the body is in two or more pieces, between which is mounted at least one sealing gasket able to cooperate with said male end piece;

the body is monobloc or formed in one-part;

the pin comprises a projection which is located opposite a hollow of complementary shape of said body, this projection being capable of being at a distance from the hollow when the pin is in its lowered position in the absence of an axial force applied to the pin, and being capable of being engaged in the hollow when the pin is in its lowered position in the presence of an axial force applied to the pin; this axial force corresponds, for example, to a force of the fluid circulating in the fluidic connector during operation.

### BRIEF DESCRIPTION OF THE FIGURES

Further characteristics and advantages will be apparent from the following description of non-limiting embodiments of the invention with reference to the accompanying drawings wherein:

FIG. 1 is a schematic perspective view of a fluidic connector according to one embodiment of the invention;

FIG. 2 is a schematic perspective view of a female end piece of the fluidic connector in FIG. 1;

FIG. 3 is a schematic side view of a body of the fluidic connector of FIG. 1;

FIGS. 4a-4b are schematic perspective and cross-sectional views of the body shown in FIG. 3;

FIGS. 5a-5b are schematic perspective views of a pin of the fluidic connector of FIG. 1;

FIGS. 6a-6b are further schematic perspective views of the pin shown in FIGS. 5a-5b;

FIG. 7 is a schematic axial cross-section of the female end piece of the fluidic connector in FIG. 1;

FIGS. 8a-8b are further schematic cross-sectional views of the female end piece of the fluidic connector of FIG. 1;

FIG. 9 is a similar view to FIG. 7 and shows a step wherein a male end piece is inserted into the female end piece;

FIG. 10 is a similar view to FIGS. 8a-8b and shows a step for inserting a male end piece into the female end piece;

FIG. 11 is a similar view to FIG. 7 and shows the pin in a lowered position, the pin being in a raised position in FIG. 7;

FIG. 12 is a similar view to FIGS. 8a-8b and shows the pin in the lowered position, the pin being in the raised position in FIGS. 8a-8b;

FIG. 13 is a schematic perspective view of a pin according to a variant of embodiment of a fluidic connector according to the invention;

FIG. 14 is a schematic perspective view of a female end piece body according to a variant of embodiment as shown in FIG. 13;

FIG. 15 is a schematic cross-sectional perspective view of the female end piece in the alternative embodiment shown in FIG. 13;

FIG. 16 is a schematic perspective view of a variant embodiment of the pin;

FIG. 17 is a schematic perspective view of a variant embodiment of the body of the female end piece; and

FIG. 18 is a schematic axial cross-sectional view of the alternative variants of embodiment of FIGS. 16 and 17, with the pin in its lowered position.

### DETAILED DESCRIPTION OF THE INVENTION

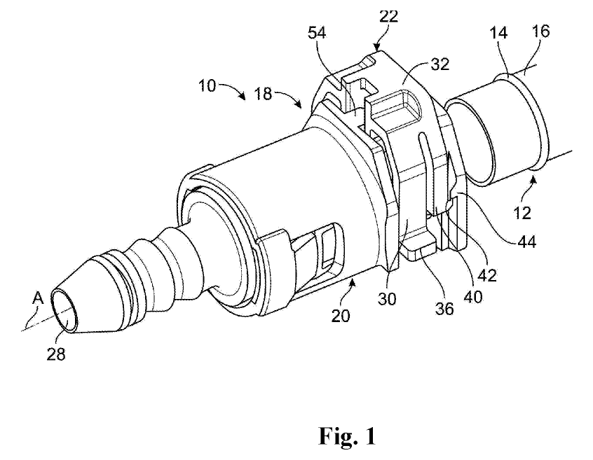

FIG. 1 shows an example of embodiment of a fluidic connector 10 according to the invention.

The connector 10 is particularly suitable for a use in a fluid circuit, in particular automotive, such as an air conditioning or cooling circuit for example.

The connector 10 comprises a male end piece 12 of the SAE type with an external annular rib 14. In a known way, such an end piece 12 has a generally tubular shape and comprises an external cylindrical surface 16 from which the rib 14 projects.

The connector 10 comprises a female end piece 18 suitable for receiving the male end piece 12.

The female end piece 18 comprises a body 20 and a single pin 22.

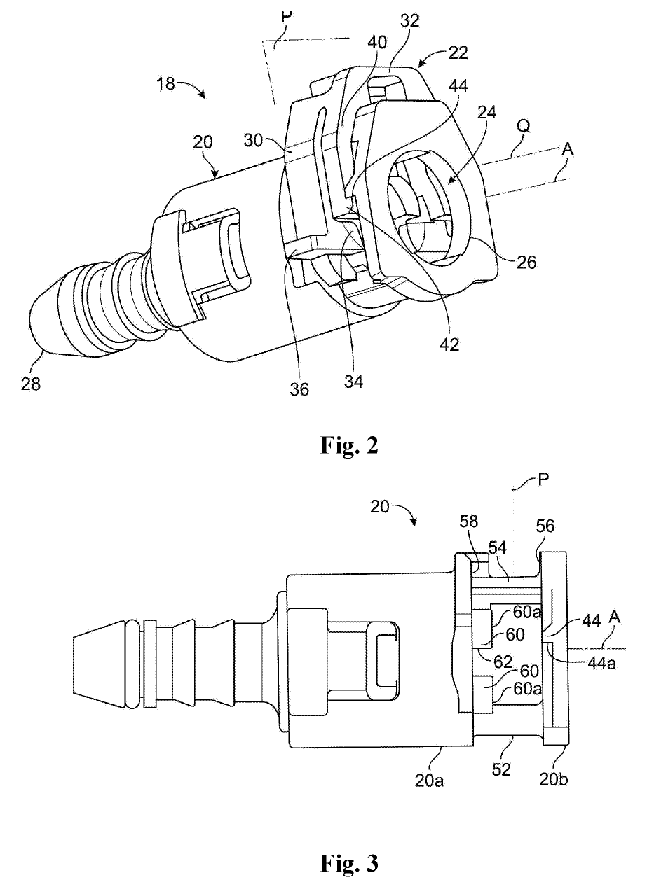

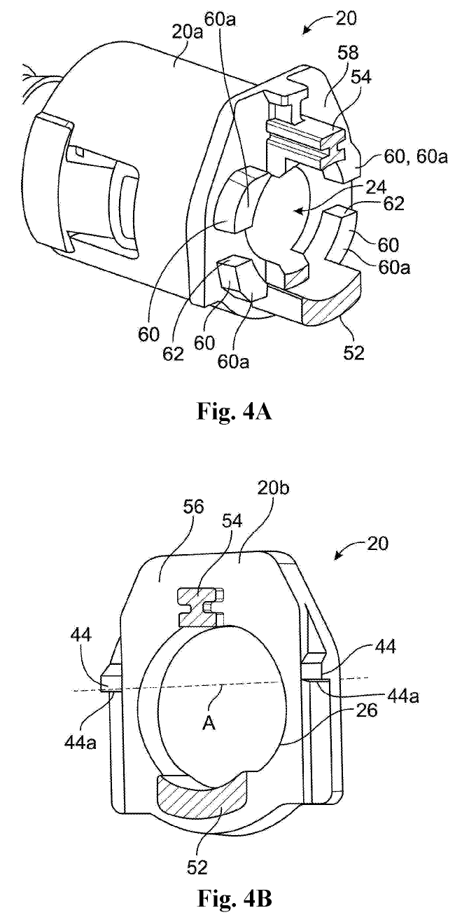

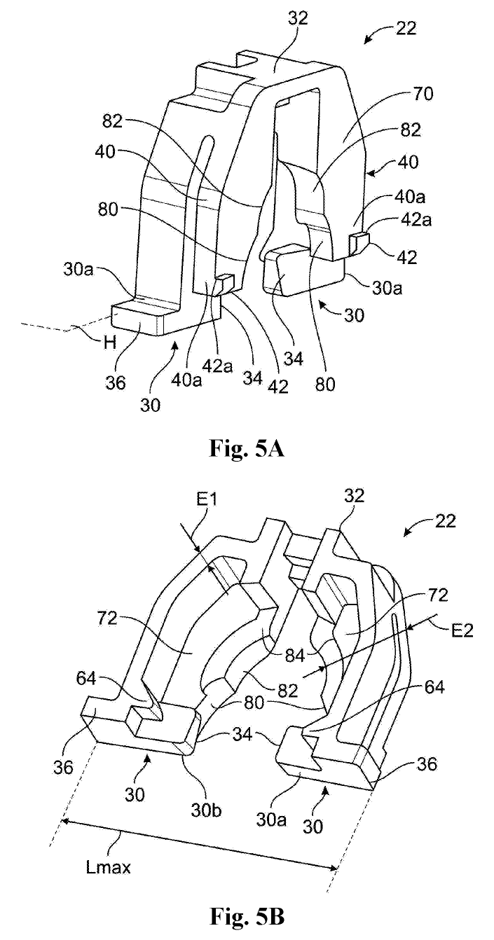

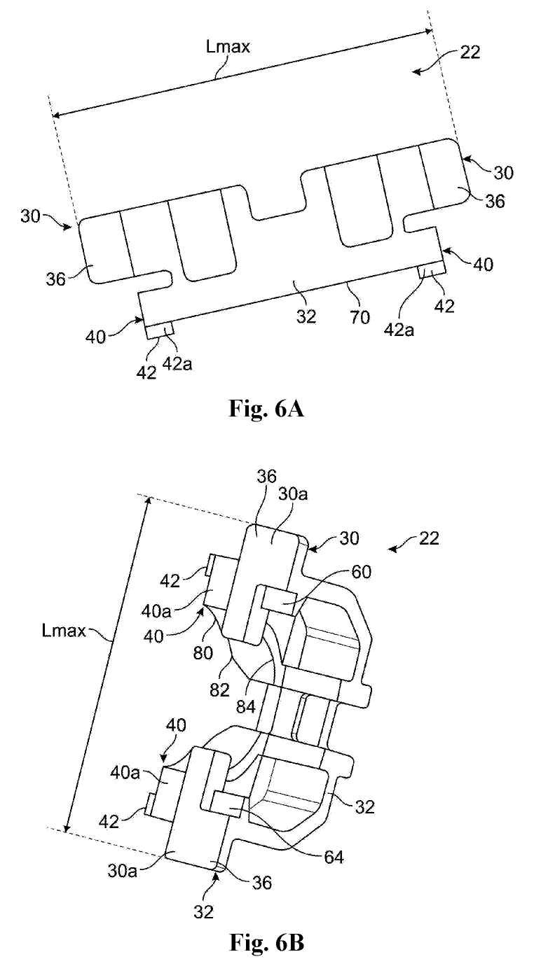

The female end piece 18 is shown on its own in FIG. 2. The body 20 is shown on its own in FIGS. 3 and 4a-4b and the pin 22 is shown on its own in FIGS. 5a to 6b.

The body 20 comprises an internal fluid passage 24 extending from an inlet 26 to an outlet 28. In the example shown, the inlet 26 and the outlet 28 are coaxial.

The passage 24 is able to receive the male end piece 12 by engagement from the inlet 26 along an axis A.

The pin 22 is mounted astride the body 20 and is capable of axially retaining the male end piece 12 in the passage 24 of the body 20.

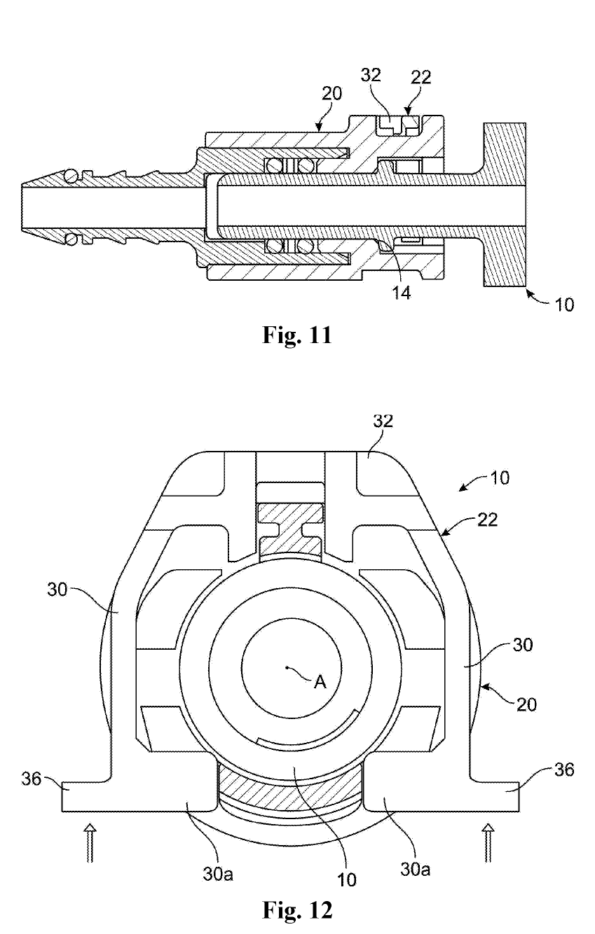

The pin 22 is formed in a single piece and is movable in a plane perpendicular to the axis A from a raised position for releasing the male end piece 12, visible in FIGS. 1, 2, 7, 8a-8b, 9, 10, to a lowered position for retaining the male end piece 12, visible in FIGS. 11, 12 and 18.

The pin 22 comprises a first pair of lateral tabs 30 which are located on either side of the axis A and which extend parallel to the plane P from a median part 32 of the pin 22.

The tabs 30 of the first pair comprise, at their free ends 30a opposite the median part 32, ramps 34 on which the rib 14 of the male end piece 12 is able to bear, in particular when the pin is in the raised position, when the male end piece 12 is engaged in the female end piece 18, in order to move these tabs 30 elastically away from each other.

At their free ends 30a, the tabs 30 also have gripping projections 36 that may be manipulated by an operator in order to move the pin 22 from its lowered position to its raised position.

The pin 22 also comprises a second pair of lateral tabs 40 which are located on either side of the axis A and which extend parallel to the plane P from the median part 32 of the pin 22 and at an axial distance from the tabs 30.

The tabs 40 are located between the tabs 30 and the inlet 26 and comprise, at their free ends 40a opposite the median part 32, first teeth 42 which are oriented parallel to the axis A on the side opposite the tabs 30.

The teeth 42 are able to cooperate by bearing with complementary second teeth 44 on the body 20 in order to define the raised position and prevent the pin 22 from becoming accidentally detached from the body 20. The teeth 44 may be seen in FIGS. 1, 2, 3, 4b and 14 in particular.

The tabs 40 are able to cooperate by bearing axially against the rib 14 of the male end piece 12 when the pin 22 is in the lowered position, to retain the male end piece 12 axially in the female end piece 18.

We will now describe in more detail the embodiment illustrated in FIGS. 1 to 12 and how it works.

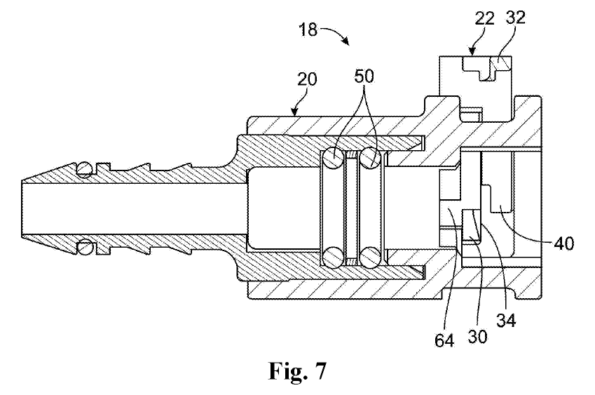

The body 20 of the female end piece 18 is formed by the assembly of two or more pieces in the example shown, between which is mounted at least one sealing gasket 50 capable of cooperating with the male end piece 12 and in particular its external surface 16 (FIGS. 1 and 7). Alternatively, the body 20 may be monobloc or formed in one-part.

As shown in FIGS. 4a and 4b, the body 20 comprises a tubular section 20a and a ring 20b connected to the section 20a.

The ring 20b is coaxial with the section 20a and connected to the section 20a by two material bridges 52, 54 parallel to the axis A and diametrically opposed with respect to this axis A.

It is the ring 20b that defines the aforementioned inlet 26 in the example shown.

The teeth 44 may project from a face 56 of the ring, or into recesses in this face 56 of the ring (FIG. 4b). The face 56 is perpendicular to the axis A and faces the side of the section 20a.

The material bridges 52, 54 extend from the ring 20b and are connected to this face 56.

Similarly, the section 20a comprises a face 58 perpendicular to the axis A and facing the face 56 of the ring 20b. The material bridges 52, 54 are connected to this face 58.

The face 58 also comprises two projections 60 which are arranged on either side of the axis A, and between the material bridges 52, 54. Each of these projections 60 comprises a notch 62 substantially in the middle which is oriented radially with respect to the axis A.

The notches 62 may be seen as forming housings for receiving teeth 64 of the tabs 30, or defining hooks able to cooperate with teeth 64 of the tabs 30.

Each of the projections 60 comprises a face 60a facing the face 56 and separated from this face 56 by a predetermined axial distance (FIG. 3). The faces 56, 58 and 60a are used to guide the pin 22 as it moves in the plane P.

In the example shown, if we consider that the material bridges 54, 52 are respectively located at the top and bottom with respect to the axis A and the passage 24, then the projections 60 are located to the left and right of the axis A and the passage 24.

The pin 22 is mounted astride the material bridges 54, 52, particularly when in the lowered position shown in FIG. 12.

The tabs 30 of the pin 22 have a greater capacity for elastic deformation in bending about axes parallel to the axis A than the tabs 40. In other words, the tabs 30 are softer and more flexible than the tabs 40.

In practice, the tabs 30 may have a radial thickness E1 (with respect to the axis A) at the level of their connection to the median part 32, which is less than half or even less than one third of a radial thickness E2 (with respect to the axis A) of the tabs 40 at the level of their connection to the median part 32, as may be seen in FIG. 5b in particular.

The tabs 30 preferably comprise two first hooks 64 which are oriented radially towards the axis A (FIG. 5b).

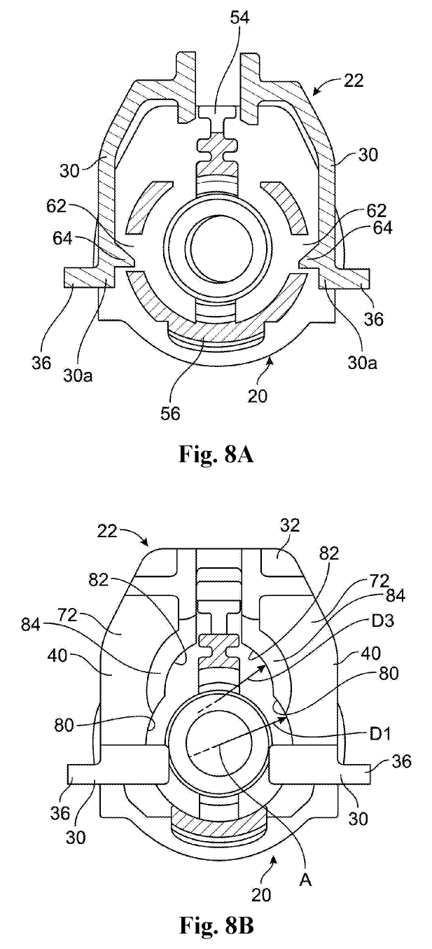

The hooks 64 are able to cooperate by engagement and/or bearing with the notches 62 (or the teeth defined by these notches) of the body 20, as may be seen in FIG. 8a, in order to prevent the pin 22 from moving from its raised position to its lowered position without the tabs 30 being moved apart by the rib 14 of the male end piece 12.

These hooks 64 may be located axially just behind the ramps 34 with respect to the direction of engagement of the male end piece 12 in the female end piece 16, as may be seen in FIGS. 5b and 6b.

The first hooks 64 may be located at the level of the gripping projections 36, as may be seen in the same figures.

FIGS. 6a and 6b also show that the projections 36 define a maximum width Lmax of the pin 22, which makes them easier to grip manually.

The first teeth 42 of the tabs 40 each comprise a flat upper face 42a bearing on a flat lower face 44a of each of the second teeth 44 of the body 20 (FIGS. 5a and 4b). The faces 42a, 44a may be parallel to the axis A for the body 20 (and to the axis Q for the pin 22) or inclined with respect to this axis, in particular to improve the retention of the pin 22.

The upper faces 42a of the teeth 42 are preferably located in the same plane H parallel to the axis A.

It is therefore understood that the lower faces 44a of the teeth 44 are located in this plane H when the pin 22 is in the raised position and the faces 42a, 44a are bearing against with each other (FIG. 2).

FIGS. 5a and 6a show in particular that the first teeth 42 project from an end face 70 of the pin 22 which extends over the tabs 40 as far as the median part 32.

When the pin 22 is mounted in the body 20, the face 70 faces the aforementioned face 56 of the ring 20b.

The pin 22 comprises a face 72, opposite the face 70, which also extends over the tabs and up to the median part 32 (FIG. 5b). This face 72 is therefore located on the same side as the tabs 40.

FIGS. 5a, 5b and 8b show that the tabs 40 may each comprise two first concave curved edges 80 having a diameter D1 greater than or equal to an external diameter D2 of the rib 14 of the male end piece 12 (FIGS. 8b and 10).

The tabs 40 may also each comprise two concave second curved edges 82 with a diameter D3 smaller than this external diameter D2 (FIGS. 8b and 10).

As may be seen in FIG. 8b, the edges 80 are centered on the axis A when the pin 22 is in the raised position, and the second edges 82 are configured to be centered on the axis A when the pin 22 is in the lowered position.

FIGS. 5b and 8b also show that the second edges 82 are thickened axially relative to the first edges to form axial projections 84 on the side of the tabs 30.

The tabs 40 are able to cooperate by axial bearing of the projections 84 with the rib 14 of the male end piece 12 when the pin 22 is in the lowered position, to retain the male end piece 12 axially in the female end piece 18.

When the pin 22 is in the raised position, the male end piece 12 may be engaged in the female end piece 18 by passing between the tabs 30, in particular at the level of the edges 80. When the pin 22 is in the lowered position, the male end piece 12 is retained axially by the tabs 30 and its rib 14 is bearing axially on the protrusions 84 of the edges 82.

Further aspects of the operation of the connector 10 will now be described with reference to FIGS. 7 to 12.

FIGS. 7 and 8a-8b show the female end piece 18 with the pin 22 in the raised position. In this position, the hooks 64 are engaged in the notches 62 (FIG. 8a), which prevents the pin from being moved from its raised position to its lowered position without the male end piece 12 being engaged in the female end piece 18. In this position, the teeth 42 cooperate by bearing with the teeth 44, in the aforementioned plane H, to prevent the pin 22 from being detached from the body 20 (FIGS. 1 and 2). The pin 22 is then locked to the body 20.

FIGS. 1, 9 and 10 show the engagement of the male end piece 12 with the female end piece 18. The end piece 12 is aligned with the axis A and engages in the passage 24 through the inlet 26.

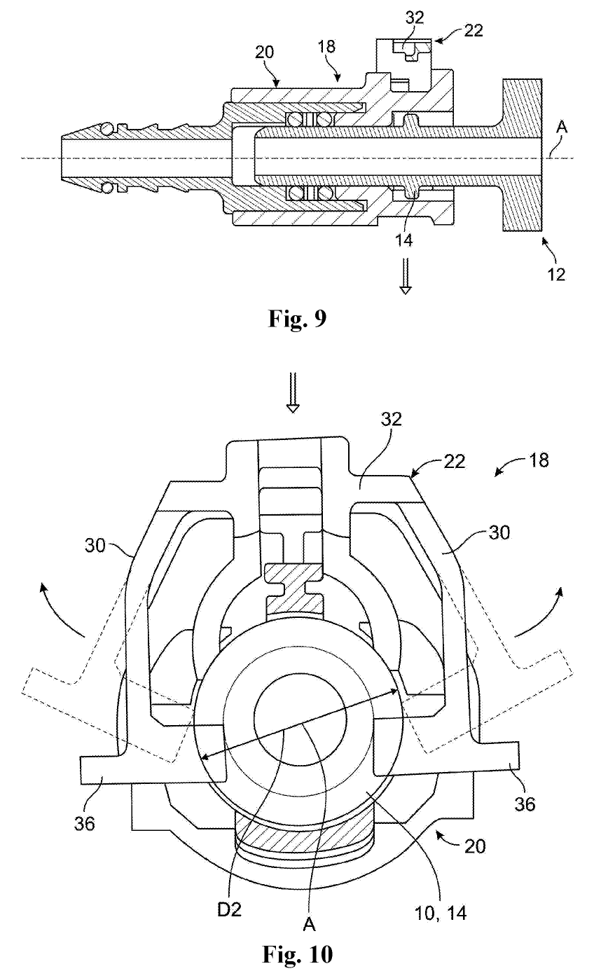

This engagement is continued until the rib 14 of the end piece 12 is axially bearing on the ramps 34 of the tabs 30, which then elastically deform away from each other, radially outwards with respect to the axis A (FIGS. 9 and 10). FIG. 10 shows in dotted lines the deformed positions (exaggerated to improve clarity and understanding) of the tabs 30 when they bear radially on the external periphery of the rib 14.

Insofar as the hooks 64 are on the deformed tabs 30, these hooks 64 are dislodged from the notches 62 when the tabs 30 are in this deformed state. The pin 22 is then no longer prevented from being moved from its raised position to its lowered position.

The pin 22 may thus move automatically from its raised position to its lowered position thanks to the elasticity of the tabs 30, which return to their initial shape, as illustrated by the arrows in FIGS. 9 and 10. The mere cooperation of the free ends 30a of the tabs 30 with the rib 14 of the end piece 12 may be sufficient for the tabs 30 to slide over the rib 14, dragging the pin 22 from its raised position to its lowered position.

The pin 22 may comprise at least one indexing and/or guiding element capable of cooperating by complementary shapes with a complementary element of the body 20 to prevent an incorrect mounting and guide this mounting. In the example shown, this element may be formed or carried by the median part 32, which has a specific shape complementary to the body 20. FIG. 1 shows, for example, that the median part 32 has a complementary shape to the material bridge 54, so that the pin 22 may only be mounted in one way on the body 20.

FIGS. 11 and 12 show the pin 22 in its lowered position, wherein the tabs 30 have returned to a stress-free position. In this position, the ends 30a of the tabs 30 preferably cooperate with the body 20 to ensure a certain retention of the pin 22 in this position.

However, it is sufficient for an operator to exert a pressure force on the gripping projections 36, as shown by the arrows in FIG. 12, to move the pin from its lowered position to its raised position, and thus allow the male end piece 12 to be removed from the female end piece 18.

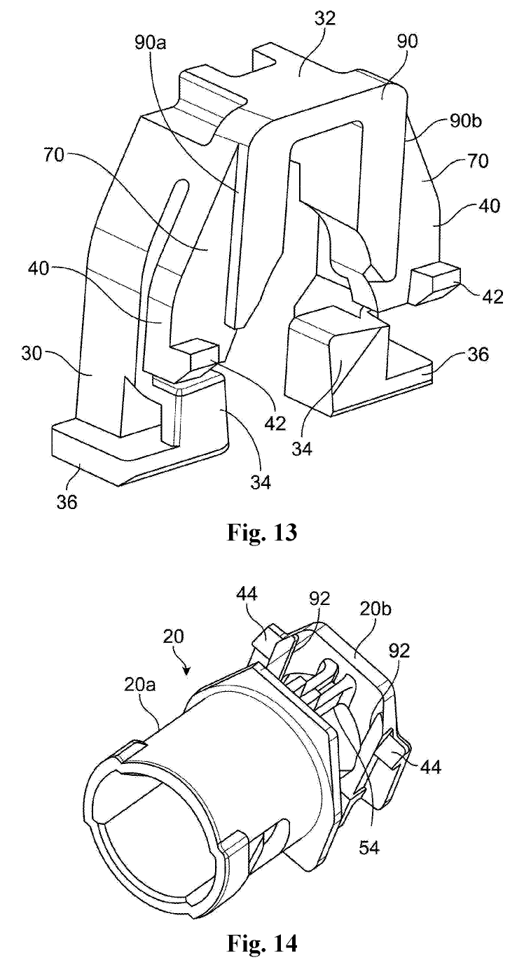

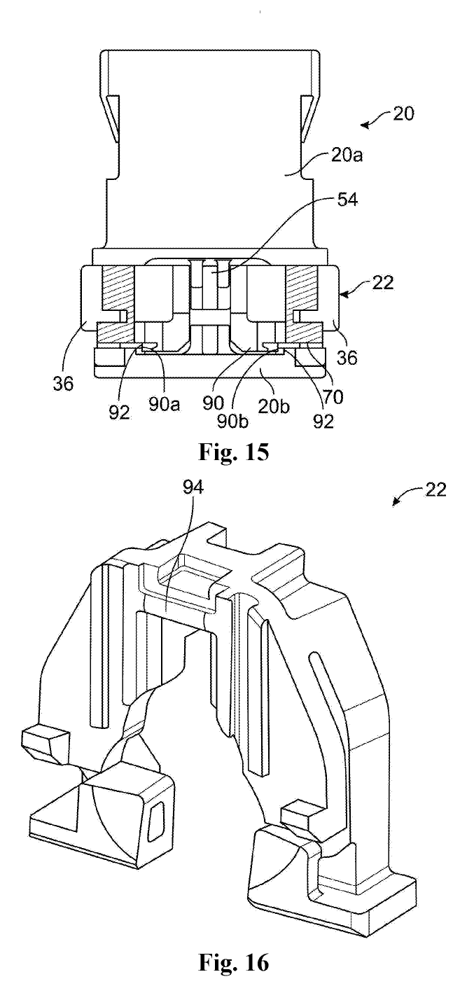

FIGS. 13 to 15 show a variant of embodiment of the fluidic connector 10 which differs from that previously described essentially in that the end face 70 comprises a projecting boss 90.

This boss 90 defines two lateral guide edges 90a, 90b which are located on either side of the axis A and which are able to cooperate by sliding with complementary tracks 92 of the body 20 when the pin 22 is moved between its raised and lowered positions.

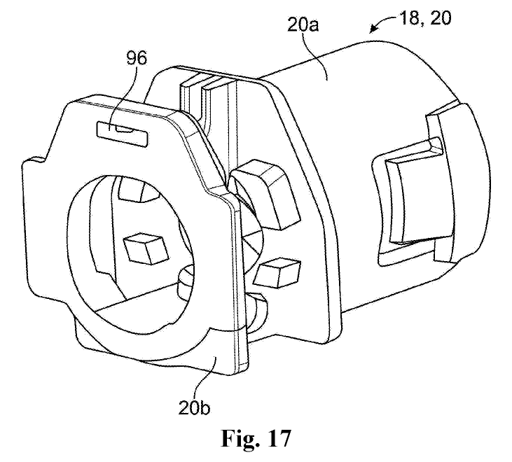

FIGS. 16 to 18 illustrate another alternative embodiment which differs from the previous embodiments essentially in that the pin 22 comprises a projection 94 which is located opposite a hollow 96 of complementary shape in the body 20.

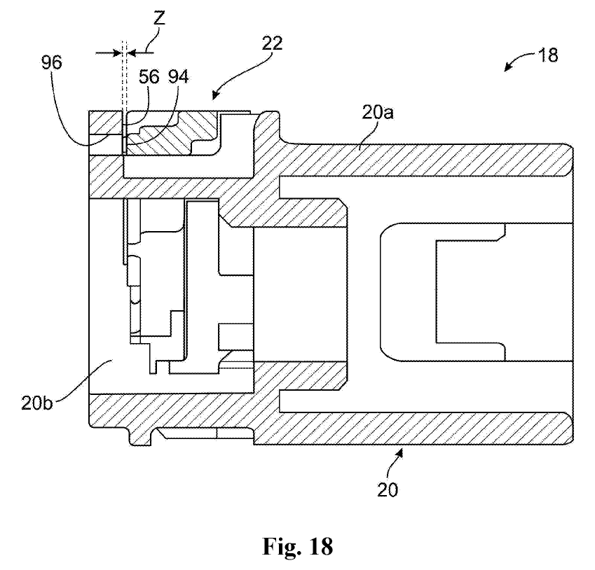

The projection 94 is able to be at a distance from the hollow 96 (axial clearance Z in FIG. 18) when the pin 22 is in its lowered position in the absence of axial force applied to the pin 22.

The projection 94 may also be engaged in the hollow 96 when the pin 22 is in its lowered position in the presence of an axial force applied to the pin 22.

In the example shown, the projection 94 is located on the median part 32, for example on the aforementioned face 70 or the aforementioned boss 90. The projection 94 is elongated in the transverse direction, for example.

The hollow 96 is located on the ring 20b of the body 20 and may take the form of a through slot or notch as shown in the example. The hollow 96, for example, has an elongated shape in the transverse direction.

During operation, the fluid circulating through the connector 10 applies an axial force to the male end piece 12, which in turn applies an axial force to the pin 22, which is then pressed against the aforementioned face 56. The projection 94 is then engaged in the hollow 96 to prevent any rise in the pin 22 under the pressure of the fluid.

Alternatively, the projection may be located on the body 20 and the corresponding hollow may be located on the pin 22.

We claim:

1. A fluidic connector for a fluid circuit, in particular automotive, this connector comprising a male end piece of the SAE type comprising an external annular rib, and a female end piece suitable for receiving the male end piece, the female end piece comprising:
a body comprising an internal fluid passage extending from an inlet to an outlet, said passage being adapted to receive the male end piece by engagement from the inlet along an axis (A), and
a single pin mounted astride the body and capable of axially retaining the male end piece in the passage of the body,
the single pin being formed in a single piece and being movable in a plane (P) perpendicular to the axis (A) from a raised position for releasing the male end piece to a lowered position for retaining the male end piece,
the pin comprising a first pair of lateral tabs which are located on either side of the axis (A) and which extend parallel to the plane (P) from a median part of the pin, the tabs of the first pair comprising, at their free ends opposite the median part, ramps on which the rib of the male end piece may bear when the pin is in the raised position and when the male end piece engages in the female end piece, in order to move these tabs elastically away from one another, the tabs (30) of the first pair being able to cooperate by bearing axially against the rib of the male end piece when the pin is in the lowered position, in order to retain the male end piece axially in the female end piece, the tabs of the first pair also comprising, at their free ends, gripping projections that may be manipulated by an operator in order to move the pin from its lowered position to its raised position, the pin further comprising a second pair of lateral tabs which are located on either side of the axis (A) and which extend parallel to the plane (P) from the median part of the pin and at an axial distance from the tabs of the first pair, the tabs of the second pair being located between the tabs of the first pair and said inlet and comprising, at their free ends opposite the median part, first teeth which are oriented parallel to the axis (A) on the side opposite the first pair of tabs and which are able to cooperate by bearing with complementary second teeth of the body in order to define said raised position and prevent the pin from becoming accidentally detached from the body.

2. The connector according to claim 1, wherein the tabs of the first pair have a capacity for elastic deformation in bending about axes parallel to the axis (A), which is greater than that of the tabs of the second pair.

3. The connector according to claim 2, wherein the tabs of the first pair have, at a level of their connection to the median part, a radial thickness (E1) which represents less than half or even less than one third of a radial thickness (E2) of the tabs of the second pair at the level of their connection to the median part, the radial thicknesses (E1, E2) being measured with respect to the axis (A).

4. The connector according to claim 1, wherein each of the first teeth comprises a plane upper face bearing on a plane lower face of each of the second teeth, the upper faces of the teeth of the first pair of tabs being located in the same plane (Q) parallel to the axis (A).

5. The connector according to claim 1, wherein the first teeth project from an end face of the pin which extends over the tabs of the second pair as far as the median part.

6. The connector according to claim 5, wherein a boss projects from the end face, this boss defining two lateral guide edges which are located on either side of the axis (A) and which are able to cooperate by sliding with complementary tracks of the body when the pin is moved between its raised and lowered positions.

7. The connector according to claim 1, wherein the tabs of the first pair comprise two first hooks which are oriented radially towards the axis (A) and which are capable of cooperating by bearing with complementary second hooks or notches of the body in order to prevent the pin from moving from its raised position to its lowered position without the tabs of the first pair being moved away by the rib of the male end piece.

8. The connector according to claim 7, wherein the first hooks are located at a level of the gripping projections.

9. The connector according to claim 7, wherein the first hooks are located axially just behind the ramps with respect to a direction of engagement of the male end piece in the female end piece.

10. The connector according to claim 9, wherein the first hooks are located at a level of the gripping projections.

11. The connector according to claim 1, wherein the gripping projections define a maximum width (Lmax) of the pin.

12. The connector according to claim 1, wherein the tabs of the second pair respectively comprise two first concave curved edges having a diameter (D1) greater than or equal to an external diameter (D2) of the rib of the male end piece, and two second convex curved edges having a diameter (D3) less than this external diameter (D2), the first edges being centered on the axis (A) when the pin is in the raised position, and the second edges being centered on the axis (A) when the pin is in the lowered position.

13. The connector according to claim 12, wherein the second edges are thickened axially relative to the first edges to form axial projections on the same side as the tabs of the first pair.

14. The connector according to claim 1, wherein the pin comprises at least one indexing and/or guiding element able to cooperate by complementary shapes with a complementary element of the body.

15. The connector according to claim 1, wherein the body comprises a tubular section and a ring, the ring being coaxial with the tubular section and connected to the tubular section by two material bridges parallel to the axis (A) and diametrically opposed with respect to this axis (A), the pin being mounted astride either side of the two material bridges.

16. The connector according to claim 1, wherein the pin comprises a projection which is located opposite a hollow of complementary shape of said body, this projection being capable of being at a distance from the hollow when the pin is in its lowered position in the absence of an axial force applied to the pin, and being capable of being engaged in the hollow when the pin is in its lowered position in a presence of an axial force applied to the pin.

17. The connector according to claim 1, wherein the tabs of the first pair have, at a level of their connection to the median part, a radial thickness (E1) which represents less than half or even less than one third of a radial thickness (E2) of the tabs of the second pair at the level of their connection to the median part, the radial thicknesses (E1, E2) being measured with respect to the axis (A).
